(19) United States
(12) Patent Application Publication
(10) Pub. No.: US 2022/0095585 A1
(43) Pub. Date: Mar. 31, 2022

(54) PET TOY WITH ATTRACTANT-RETAINING INTERIOR SPACE

(71) Applicant: Willinger Development LLC, Tenafly, NJ (US)

(72) Inventor: Jonathan WILLINGER, Tenafly, NJ (US)

(73) Assignee: Willinger Development LLC, Tenafly, NJ (US)

(21) Appl. No.: 17/060,006

(22) Filed: Sep. 30, 2020

(51) Int. Cl. A01K 15/02

(52) U.S. Cl. CPC A01K 15/026

(57) ABSTRACT

A pet toy includes a structural body having a first end, a second end opposite the first end, and a medial portion disposed between the first end and the second end. An attractant-retaining interior space extends throughout the medial portion; and an access is disposed in the first end for accessing the medial portion. A removable plug seals the access.

### BACKGROUND OF THE INVENTION

### 1. Field of the Invention

The invention relates generally to pet amusement and chew toy and, more particularly, to an attractant toy capable of attracting, generating, and holding interaction with a pet animal. The invention furthermore relates to a toy having a unitary, one-piece construction.

### 2. Discussion of the Related Art

As described in U.S. Patent Application Publication 2014/130750, six general criteria (“general criteria”) for a successful pet toy are: (1) non-injuriousness to a pet; (2) design, or quality, attractiveness to a purchaser; (3) initial interest by the pet; (4) continued engagement by the pet; (5) durability when played with by a pet; and (6) price attractiveness to a purchaser.

Therein, design attractiveness to a purchaser (“design attractiveness”) requires that the pet toy have an aesthetic appearance that makes the pet toy stand out among other pet toys in a retail location

As further described in the '750 publication:
“Initial interest by the pet (“initial interest”) requires that upon first encountering the pet toy, the pet should show an interest in playing with the toy. This can be achieved by an appealing shape, interesting sound, insertion of a treat, or other means.
“Initial interest does not guaranty that the pet will continue to engage the toy (“continued engagement”). Continued engagement requires that the toy presents sufficient interest, for example, by removing a treat hidden inside a pet toy, so that the pet will play with the toy even after having been exposed to it.
“Durability requires that the pet toy resist damage or destruction for a prolonged period.
“Price attractiveness to a purchaser (“price attractiveness”) requires that the selling price of the pet toy be properly positioned for the kind of pet toy that is being purchased. Since the retail price is typically multiples of the manufacturing costs, price attractiveness means that the cost of manufacture be appropriate for the toy. However, as each of the general criteria is met, the costs increase.” Quality attractiveness to a purchaser means that the goods of a sufficient quality to sustain the selling price of the pet toy be properly positioned for the kind of pet toy that is being purchased.

Thus, what is desired is a pet toy that satisfies at least some of the criteria in a cost-effective manner.

### SUMMARY OF THE INVENTION

These and other objectives are met by the present invention.

Therein, a pet toy comprises a structural body having a first end, a second end opposite the first end, and a medial portion disposed between the first end and the second end; an attractant-retaining interior space extending throughout the medial portion; an access in a first end for accessing the medial portion; and a plug received in the access for closing the access.

The structural body comprises a plurality of passages from an exterior of the pet toy to the attractant-retaining interior space to permit passage of an odor of the attractant.

A passage from an exterior of the pet toy to the attractant-retaining interior space through the second end.

A passage from an exterior of the pet toy to the attractant-retaining interior space through the plug.

Either the first end or the second end comprises an enlarged end portion.

A passage from an exterior of the pet toy to the attractant-retaining interior space through medial portion.

A passage from an exterior of the pet toy to the attractant-retaining interior space through medial portion and a passage from the exterior of the pet toy to the attractant-retaining interior space through the second end or the plug.

In combination, a pet toy and an attractant comprise
a structural body having a first end, a second end opposite the first end, and a medial portion disposed between the first end and the second end;
an attractant-retaining interior space extending throughout the medial portion; and
an access in a first end for accessing the medial portion; and
a plug received in the access for closing the access; and
an attractant.

The attractant is selected from a length of strip and a plurality of pellets.

The attractant is selected from jerky, preserved materials, cheese, one or more edible bioplastics, and/or any other suitable material or combination thereof.

The structural body comprises a plurality of passages from an exterior of the pet toy to the attractant-retaining interior space to permit passage of an odor of the attractant.

A passage from an exterior of the pet toy to the attractant-retaining interior space through the second end.

A passage from an exterior of the pet toy to the attractant-retaining interior space through the plug.

An outer periphery of the access is sized so that the attractant leaves the access through action of the pet.

In accordance with one or more embodiments of the present invention, a plug is not used and one or more attractants may be inserted via pressure fitting through the opening segment.

In accordance with one or more embodiments of the present invention, each end of the pet toy is open and has an opening segment and a plug is not used in either end. One or more attractants may be inserted via pressure fitting through the opening segment associated with each end.

Either the first end or the second end comprises an enlarged end portion.

A method of making a pet toy, includes the steps of
molding the structural body, and
drilling, reaming, or boring the structural body to form the attractant-retaining interior space.

The step of drilling, reaming, or boring the structural body forms a plurality of passages from an exterior of the pet toy to the attractant-retaining interior space to permit passage of an odor of the attractant.

The step of drilling, reaming, or boring the structural body forms a plurality of passages from an exterior of the pet toy in the medial portion to the attractant-retaining interior space to permit passage of an odor of the attractant.

The method includes the steps of:
providing the plug and an attractant;
inserting the attractant into the attractant-retaining interior space; and
sealing the attractant-retaining interior space by inserting the plug into an opening segment.

The method includes the steps of:
providing the plug and an attractant;
inserting the attractant into the attractant-retaining interior space; and
sealing the attractant-retaining interior space by inserting the plug into an opening segment.

### BRIEF DESCRIPTION OF THE DRAWINGS

These and other features are illustrated in the following diagrams:

FIG. 1a is an isometric view of a pet toy with a plug secured in the pet toy in accordance with one or more embodiments of the present invention.

FIG. 1b is an isometric view of a pet toy with a plug removed from the pet toy in accordance with one or more embodiments of the present invention.

FIG. 1c is an isometric view of a pet toy with a plug removed from the pet toy and an attractant partially disposed in a storage segment of the pet toy in accordance with one or more embodiments of the present invention.

FIG. 1d is a cross-sectional view of the pet toy of FIG. 1b along Section A-A of FIG. 1b with a plug removed from the pet toy and an attractant entirely disposed in a storage segment of the pet toy in accordance with one or more embodiments of the present invention.

FIG. 2 is a cross-sectional view of a pet toy with a plug disposed in the pet toy and a plurality of attractants entirely disposed in a storage segment of the pet toy in accordance with one or more embodiments of the present invention.

FIG. 3 is a schematic view of a method of making a pet toy in accordance with one or more embodiments of the present invention.

### DETAILED DESCRIPTION OF THE INVENTION

Reference will now be made in detail to several embodiments of the invention that are illustrated in the accompanying drawings. The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

Wherever possible, same or similar reference numerals are used in the drawings and the description to refer to the same or like parts or steps, and explanations that duplicate one another are omitted for brevity, convenience, and clarity.

The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner.

All technical and scientific terms shall have the same meaning as commonly understood by one of ordinary skill in the art. Nonetheless, the following terms defined below aid in the understanding of the disclosure. The definitions apply to all parts of speech of the term regardless whether the term is defined explicitly as such.

Accordingly, the meaning of specific terms or words used in the specification and the claims should not be limited to the literal or commonly employed sense, but should be construed in accordance with the spirit and scope of the disclosure. The definitions of these terms, therefore, may be determined based on the contents throughout the specification. Where not defined, the meaning of all terms will be clear from the context of the description.

“A” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

“About,” “approximately,” or “substantially similar” refer to one or more industry-accepted tolerances for the corresponding term and/or relativity between elements. Where such industry-accepted tolerances for the corresponding term are unknown, difficult to determine, inconsistent, or subject to experimentation, “about,” “approximately,” or “substantially similar” refer to a 10% variation from the nominal value. Even if not explicitly stated, it is understood that a variation is always included in a given value, whether or not the variation is specifically referenced. In accordance with one or more embodiments of the present invention, “about,” “approximately,” or “substantially similar” mean within 5% of the reported numerical value. In accordance with one or more embodiments of the present invention, “about,” “approximately,” or “substantially similar” mean within 10, 9, 8, 7, 6, 5, 4, 3, 2, or 1% of the reported numerical value.

“Comprises,” “comprising,” “includes,” “including,” “has,” “having,” “contains,” or “containing,” or any other variation thereof are used to describe and claim a non-exclusive inclusion such that a composition, a mixture, process, method, article, or apparatus that comprises a list of elements is not necessarily limited to only those elements but can include other elements not expressly listed or inherent to such composition, mixture, process, method, article, or apparatus. “Comprises,” “comprising,” “includes,” “including,” “has,” “having,” “contains,” or “containing,” or any other variation thereof may also be understood to mean “including, but not limited to.”

The words “connect,” “couple,” and similar terms with their inflectional morphemes do not necessarily denote direct and immediate connections, but also include connections through mediate elements or devices. Furthermore, such terms as “toy” or “chew toy” are used interchangeably.

“Connector,” “fastener,” or “fastening device” shall in the singular and plural refer to any device used for mechanically joining two or more parts, components, or the like together for its intended purpose whether temporary or permanent, including a screw, nail, anchors, clamp, cotter pin, retainer, clip, or any other device known or yet to be developed. “Connector,” “fastener,” or “fastening device” shall in the singular and plural refer to an adhesive, cement, glue, or the like. Where a specific embodiment of a “connector,” “fastener,” or “fastening device” is disclosed it shall be understood to be the preferred embodiment of a “connector,” “fastener,” or “fastening device” for reasons of economy, structural integrity, longevity and/or ease of installation.

“Component” shall in the singular and plural refer to one or more parts, elements, pieces, or other items related to a portion of the present invention.

“Invention” or “present invention” are non-limiting terms and not intended to refer to any single aspect of the particular invention but encompass all possible aspects as described in the specification and the claims.

“Mounted,” “mounted in,” or “integrated” shall mean that a first element is directly secured to or in a second element or have intervening elements be present between the first and second element. “Directly mounted” or “directly mounted in” shall mean that no intervening element is present between the first and second element and that the first element is in contact with the second element.

“On,” “over,” “disposed on,” “disposed against,” and/or “disposed over,” shall mean that a first element can be directly located on a second element or have intervening elements be present between the first and second element. “Directly on,” “directly over,” “directly against,” directly disposed against,” “directly disposed on,” and/or “directly disposed over” shall mean that no intervening element is present between the first and second element and that the first element is in contact with the second element.

“One embodiment,” “an embodiment,” “exemplary embodiment,” or variations thereof means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

“Suitable” or “suitably” in this application refers to a size and/or shape that maintains the structural integrity of the invention and/or permits the intended use of the invention by its intended user in a normal or advantageous manner.

“User” in the singular and the plural refers to a person, entity, and/or other group uses one or more aspects of the present invention. Herein, a user may be a pet owner and/or the pet as required or evident from the com in accordance with one or more embodiments of the present invention a pet toy 10 is configured to provide design attractiveness by its shape. An attractant 20 disposed in an interior of pet toy 10 is provides initial interest and continued engagement to a pet. Durability and price attractiveness are provided by the use of long-lasting moldable materials.

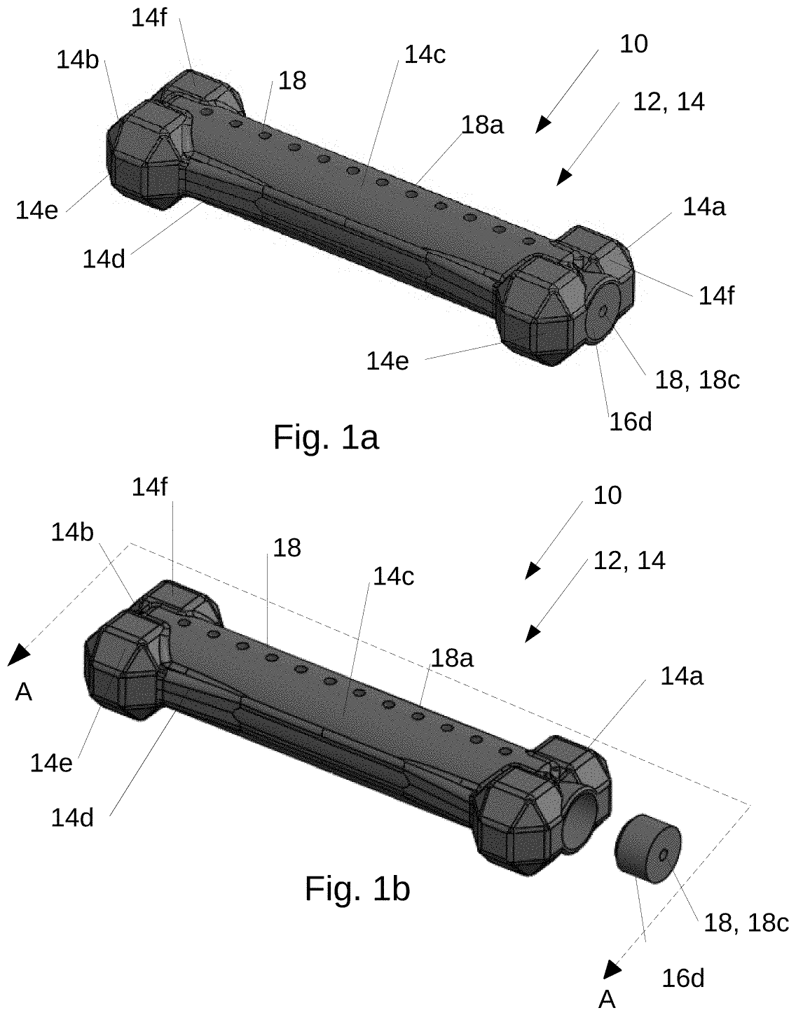

FIG. 1a is an isometric view of a pet toy with a plug secured in the pet toy in accordance with one or more embodiments of the present invention.

FIG. 1b is an isometric view of a pet toy with a plug removed from the pet toy in accordance with one or more embodiments of the present invention. Therein, FIG. 1b may depict the pet toy of FIG. 1a.

FIG. 1c is an isometric view of a pet toy with a plug removed from the pet toy and an attractant partially disposed in a storage segment of the pet toy in accordance with one or more embodiments of the present invention. Therein, FIG. 1c may depict the pet toy of FIGS. 1a and 1b.

FIG. 1d is a cross-sectional view of the pet toy of FIG. 1b along Section A-A of FIG. 1b with a plug removed from the pet toy and an attractant entirely disposed in a storage segment of the pet toy in accordance with one or more embodiments of the present invention. Therein, FIG. 1d may depict the pet toy of FIGS. 1a-1c.

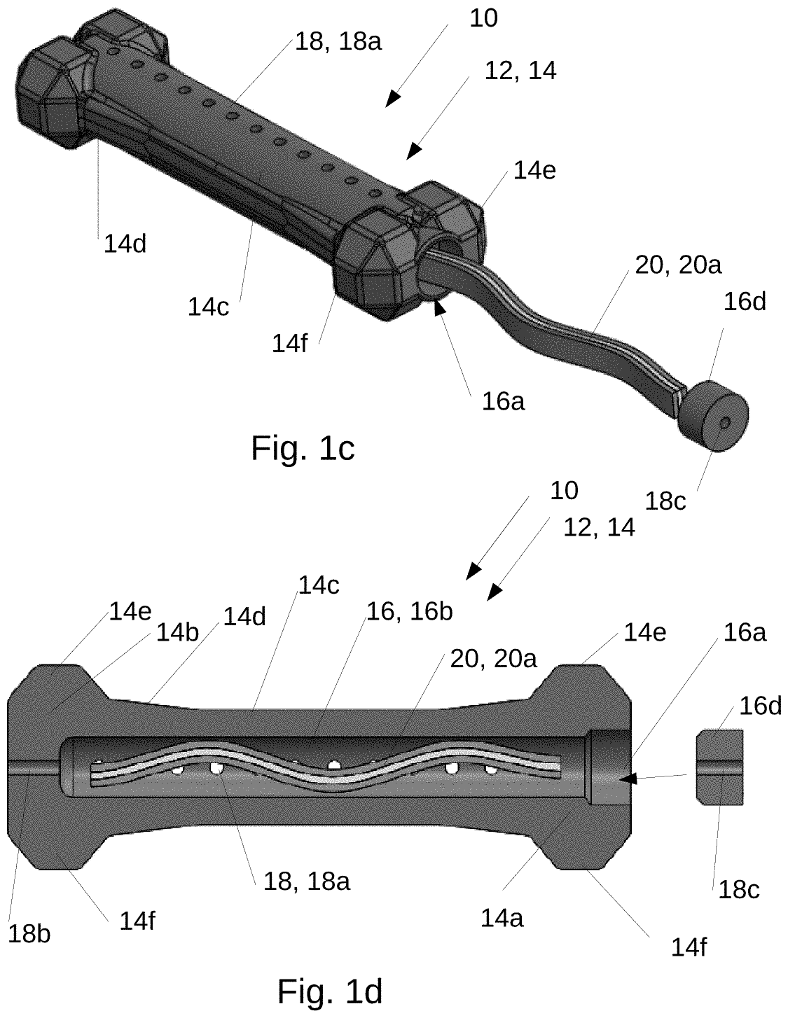

FIG. 2 is a cross-sectional view of a pet toy with a plug disposed in the pet toy and a plurality of attractants entirely disposed in a storage segment of the pet toy in accordance with one or more embodiments of the present invention. Therein, FIG. 2 may depict the pet toy of FIGS. 1a-1d.

Pet toy 10 is used by the pet, especially a dog, to chew on and may have any suitable shape, but preferably has a bone shape 12, which has a structural body 14 with a first end 14a and a second end 14b. A medial portion 14c connects, preferably connecting directly, first end portion 14a to second end 14b. Where medial portion 14c meets an end portion, one or more lateral flares 14d may strengthen the juncture between medial portion 14c and first end 14a and/or second end 14b by providing additional structural material.

Each end 14a, 14b preferably has enlarged end portions 14e, 14f to emphasize the bone shape 12. Enlarged end portions 14e, 14f aid in obtaining initial interest from the pet and in maintaining continued engagement of the pet by permitting the pet to chew enlarged end portions 14e, 14f.

An interior space 16 is used to place and store attractant 20. Interior space 16 comprises an opening segment 16a, i.e. a passage, that is disposed in the first end 14a (and in accordance with one or more embodiments of the present invention optionally in second end 14b) and a storage segment 16b in the medial portion 14c. A portion of opening segment 16a at a terminal end of end 14a or 14b define respective access holes 16e providing access into toy 10 and specifically storage segment 16b. Storage segment 16b may extend into second end 14b.

An outer periphery of opening segment 16a, i.e. access holes 16e, is sized so that the attractant leaves the access through action of the pet.

To secure a plug 16d in opening segment 16a without the plug falling into storage segment 16b, at least one dimension of opening segment 16a is larger than a storage segment 16b and plug 16d comprises that dimension minus a small dimensional tolerance for ease of fitting. For ease of fitment into opening segment 16b, plug 16d comprises one or more chamfered edges or a circumferential chamfered edge.

In accordance with one or more embodiments of the present invention, plug 16d is not used and one or more attractants 20 may be inserted via pressure fitting through opening segment 16a.

In accordance with one or more embodiments of the present invention, each end of the pet toy is open and has an opening segment and plug 16d is not used in either end. One or more attractants 20 may be inserted via pressure fitting through the opening segment associated with each end.

In accordance with one or more embodiments of the present invention, each end 14a, 14b comprises an opening segment 16a, which at a terminal end of respective end 14a or 14b define an access hole 16e providing access into toy 10 and specifically storage segment 16b.

In accordance with one or more embodiments of the present invention, storage segment 16b is circular in cross-section and is made by drilling, reaming, caming, or boring of structural body 14 or a combination thereof.

In accordance with one or more embodiments of the present invention, opening segment 16a is circular in cross-section and is made in whole or in part by drilling, reaming, caming, or boring of structural body 14 or a combination thereof.

A plurality of passages 18 are disposed in structural body 14 that connect the ambient environment to storage segment 16b. Air movement through passages 18 allow the pet to smell attractant 20, i.e. smell the odor of attractant 20. Passages 18 may have any shape or design and in accordance with one or more embodiments of the present invention are made by drilling, reaming, or boring of structural body 14.

In accordance with one or more embodiments of the present invention, passages 18 are circular in cross-section and are made by by drilling, reaming, or boring of structural body 14.

In accordance with one or more embodiments of the present invention, passages 18a are disposed in medial portion 14c and may have any shape or design, but preferably are circular in cross-section with a 2-3 mm diameter. Passages 18a may be disposed in any geometric or random pattern, but preferably in a single row or in multiple rows.

One or more passages 18b, but preferably one passage 18b, are disposed through second end 14b to connect the ambient environment to storage segment 16b Similarly, one or more passages 18c, but preferably one passage 18c, are disposed through plug 14d connect the ambient environment to storage segment 16b.

If a single passage 18c and/or a single passage 18c are provided, the diameter of respective passage 18b and/or passage 1d is larger than a passage 18a.

A user, such as a pet owner (or the manufacturer of pet toy 10), places attractant 20 through opening segment 16a into storage segment 16b. Attractant 20 may be in any suitable shape, but preferably is the form of a strip or one or more pellets or portions.

In accordance with one or more embodiments of the present invention, attractant 20 is made from jerky, preserved materials, cheese, one or more edible bioplastics, and/or any other suitable material or combination thereof. Attractant 20 may be a single unitary attract of any shape (attractant 20a in FIGS. 1c-1d) or a plurality of attractants 20b in FIG. 2d).

In accordance with one or more embodiments of the present invention, attractant 20a may have any suitable shape or size.

In accordance with one or more embodiments of the present invention, attractant 20b may have any suitable shape or size.

Advantageously, the attractant in pet toy 10 remains in the attractant-retaining interior space of storage segment 16b.

In accordance with one or more embodiments of the present invention, plug 16d is not used and attractant 20 leaves storage segment 20b and opening segement 16a, specifically through one or more access holes 16e, through chewing and playing by the user, i.e. dog.

In accordance with one or more embodiments of the present invention, structural body 14 consists of or comprises any suitable a structural material 22, which preferably, but not necessarily, is moldable. However, preferably, material 22 may be selected from edible biodegradable bioplastic or a bioresin, and/or in particular, material 22 may be selected from, but not limited to, gluten-based polymers, wheat gluten-based polymers, gluten-chitosan based blend polymers, agricultural polymers, but not limited to, polybutylene adipate terephthalate (PBAT), polycaprolactone (PC), polylactic acid (PLA), polyhydroxyalkanoates (PHA), and/or any desired combination thereof.

In accordance with one or more embodiments of the present invention, material 22 may also be made of nylon for the advantages of durability and price attractiveness.

In accordance with one or more embodiments of the present invention, material 22 may also be made of thermoplastic rubber, rubber, or natural rubber for the advantages of quality attractiveness to a purchaser, durability, and price attractiveness.

In accordance with one or more embodiments of the present invention, material 22 may also be made of starch for the advantages of quality attractiveness to a purchaser and price attractiveness.

In accordance with one or more embodiments of the present invention, material 22 may also be made of a hard plastic like nylon, rubber, thermoplastic rubber or a more readily edible material such as one derived from starch like materials.

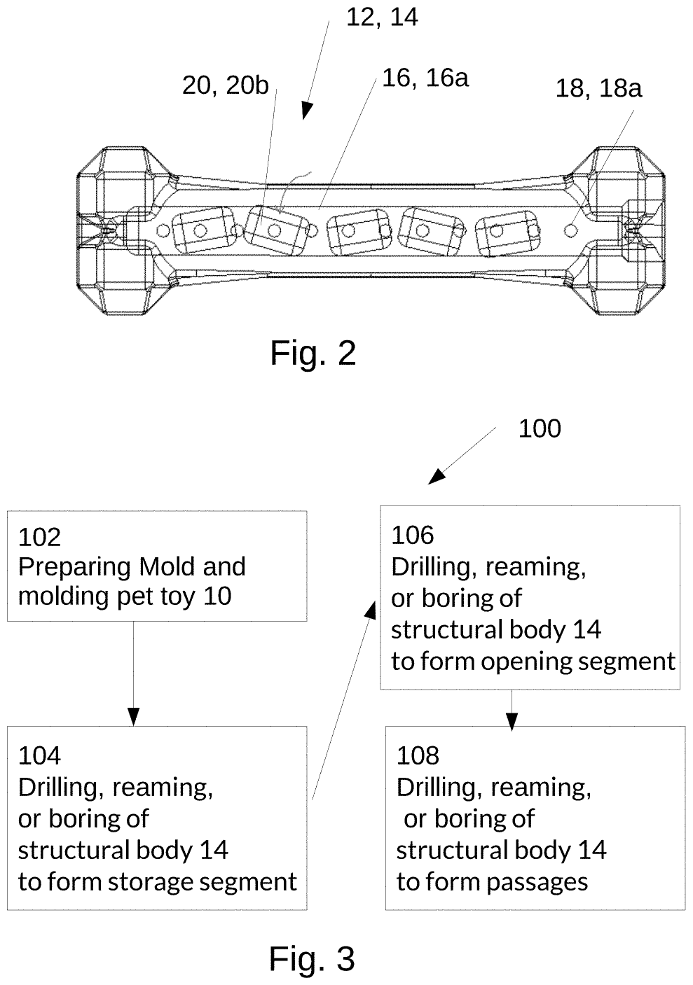

FIG. 3 is a schematic view of a method of making a pet toy in accordance with one or more embodiments of the present invention.

In a first step 102 of a method 100 of making pet toy 10, a mold is prepared and pet toy 10 is preferably made by molding structural shape 14 in a mold using moldable structural material 22. In a subsequent step 104, storage segment 16b is made by drilling, reaming, or boring of structural body 14. In a further step 106, opening segment 16a is made by drilling, reaming, or boring of structural body 14 to have at least one dimension larger than storage segment 16b. Then in step 108, passages 18 are provided by drilling, reaming, or boring of structural body 14. At the same time, a subsequent step, or separate from the present method, plug 16d is molded. Step 108 may also be performed by a cam associated with the mold such that opening segment 16a and storage segment 16b are formed in their respective entirety or in part. Advantageously, this avoids using reaming and avoids the material waste from structural body 14 caused by reaming even if recycled.

Step 108 may also be performed by a cam associated with the mold such that opening segment 16a and storage segment 16b are formed throughout structural body 14 by passing the cam from one end structural body 14 to the other end of structural body 14 so that storage segment 16b extends completely through structural body 14.

In accordance with one or more embodiments of the present invention, pet toy 10 may have any suitable shape or size.

While the invention has been described in conjunction with specific embodiments, it is to be understood that many alternatives, modifications, and variations will be apparent to those skilled in the art in light of the foregoing description.

1. A pet toy, the pet toy comprising:
a unitary structural body having a first end, a second end opposite the first end, and a medial portion disposed between the first end and the second end;
the unitary structural body defining an attractant-retaining interior space for receiving an attractant in the medial portion, the attractant-retaining interior space extending throughout the medial portion;
a plurality of passages extending through the unitary structural body from an exterior of the pet toy to the attractant-retaining interior space to permit passage of an odor of the attractant;
an access in a first end for accessing the medial portion; and
a plug received in the access for closing the access.

2. The pet toy of claim 1, wherein each passage of the plurality of passages is sized smaller than the attractant to retain the attractant in the attractant-retaining interior space and prevent dispensing the attractant through the passage.

3. The pet toy of claim 1, further comprising a passage from an exterior of the pet toy to the attractant-retaining interior space through the second end.

4. The pet toy of claim 1, further comprising a passage from an exterior of the pet toy to the attractant-retaining interior space through the plug.

5. The pet toy of claim 1, wherein either the first end or the second end comprises an enlarged end portion that deter rolling of the pet toy.

6. The pet toy of claim 1, further comprising a passage from an exterior of the pet toy to the attractant-retaining interior space through the medial portion.

7. The pet toy of claim 1, further comprising a passage from an exterior of the pet toy to the attractant-retaining interior space through medial portion and a passage from the exterior of the pet toy to the attractant-retaining interior space through the second end or the plug.

8. In combination, a pet toy for a pet and an attractant for attracting a pet,
the pet toy comprising:
a unitary structural body having a first end, a second end opposite the first end, and a medial portion disposed between the first end and the second end;
the unitary structural body defining an attractant-retaining interior space extending throughout the medial portion;
a plurality of passages from an exterior of the pet toy to the attractant-retaining interior space to permit passage of an odor of the attractant; and
an access in a first end for accessing the medial portion; and
the attractant.

9. The combination of claim 8, wherein the attractant is selected from a length of strip and a plurality of pellets.

10. The combination of claim 8, wherein the attractant is selected from jerky, preserved materials, cheese, one or more edible bioplastics, or combination thereof.

11. The combination of claim 8, wherein each passage of the plurality of passages is sized smaller than the attractant to retain the attractant in the attractant-retaining interior space and prevent dispensing the attractant through the passage.

12. The combination of claim 8, further comprising a passage from an exterior of the pet toy to the attractant-retaining interior space through the second end.

13. The combination of claim 8, further comprising a passage from an exterior of the pet toy to the attractant-retaining interior space through the plug.

14. The combination of claim 8, wherein either the first end or the second end comprises an enlarged end portion that deter rolling of the pet toy.

15. The combination of claim 8, wherein an outer periphery of the access is sized so that the attractant leaves the access through action of the pet.

16. A method of making a pet toy,
the pet toy comprising:
a unitary structural body having a first end, a second end opposite the first end, and a medial portion disposed between the first end and the second end;
the unitary structural body defining an attractant-retaining interior space extending throughout the medial portion; and
a plurality of passages extending from an exterior of the pet toy to the attractant-retaining interior space to permit passage of an odor of the attractant;
an access in a first end for accessing the medial portion; and
a plug received in the access for closing the access;
the method comprising the steps of:
molding the unitary structural body, and
drilling, reaming, caming, or boring the unitary structural body to form the attractant-retaining interior space;
drilling, reaming, caming, or boring the unitary structural body to form a plurality of passages from an exterior of the pet toy to the attractant-retaining interior space to permit passage of an odor of the attractant;
wherein each passage of the plurality of passages is sized smaller than the attractant to retain the attractant in the attractant-retaining interior space and prevent dispensing the attractant through the passage.

17. The method claim 16, further comprising the step of providing the attractant.

18. The method claim 16, further comprising the step of drilling, reaming, caming, or boring the unitary structural body to form a plurality of passages from an exterior of the pet toy in the medial portion to the attractant-retaining interior space to permit passage of an odor of the attractant.

19. The method of claim 16, further comprising the steps of
providing the plug and an attractant;
inserting the attractant into the attractant-retaining interior space; and
sealing the attractant-retaining interior space by inserting the plug into an opening segment.

20. The method of claim 18, further comprising the steps of
providing the plug and an attractant;
inserting the attractant into the attractant-retaining interior space; and
sealing the attractant-retaining interior space by inserting the plug into an opening segment.
